(19) United States
(12) Patent Application Publication
(10) Pub. No.: US 2010/0278133 A1
(43) Pub. Date: Nov. 4, 2010

(54) Method And Arrangements For Facilitating Allocation Of Radio Resources

(75) Inventor: Claes Tidestav, Balsta (SE)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/808,491

(22) PCT Filed: Dec. 18, 2007
(86) PCT No.: PCT/SE2007/051028

§ 371 Date: Jun. 16, 2010

(51) Int. Cl. H04W 52/18; H04W 72/08

(52) U.S. Cl. 370/329; 455/522

(57) ABSTRACT

The present invention relates to methods and arrangements for facilitating the allocation of radio resources in a communication network, comprising a communication network node communicating with a user equipment by means of data stream transmissions over a radio interface on radio channels. What power allocation said communication network node will use for next to said user equipment incoming data transmission is predicted. Based on the power allocation prediction information on if a single data stream transmission or if a multi data stream transmission is selected for said communication is transmitted from the user equipment to the communication network node in a channel quality message. Whereby said communication network node is arranged to allocate available radio resources based on said channel quality message.

### TECHNICAL FIELD

The present invention relates to methods and arrangements in a communication network system and, more particular, to arrangements allowing for facilitating allocation of radio resources as well as methods for such facilitation.

### BACKGROUND OF THE INVENTION

Link adaptation is a fundamental technique in packet-based wireless communication systems. Based on measurements reports of the channel quality, the transmitter adjusts the coding and modulation of the transmitted signal to achieve a desired block error rate, and maximize the throughput.

The receiver typically estimates the received quality of a pilot signal. In HSDPA (High-Speed Downlink Packet Access), this quality measure is then scaled to map to a predicted quality of the HS-DSCH (High-speed downlink shared channel) assuming a nominal power of the data channel (HS-DSCH), see 3GPP TS 25.214 v.7.2.0. 3rd Generation Partnership Project; Technical Specification Group Radio Access Network; Physical layer procedures (FDD) (Release 7). The CQI report can thus be said to reflect a nominal quality of the HS-DSCH. At the subsequent transmission instant, the actual available HS-DSCH power may differ from the nominal power assumed by the UE (User Equipment). However, the base station, in this context called node B, can easily scale the nominal quality using the difference between the nominal power and the actual available HS-DSCH power:

$${RxQual}_{actual} = {RxQual}_{no min al} \times \frac{{P}_{HS - DSCH}^{actual}}{{P}_{HS - DSCH}^{nom}} \qquad ( 1 )$$

With state-of-the-art receivers, this scaling procedure works well, irrespective of the difference between nominal and actual HS-DSCH power.

The introduction of multiple-input multiple-output (MIMO) transmission in the third generation partnership project (3GPP) release 7 will lead to a significant increase in data rate in good channel conditions. With the MIMO scheme standardized for high speed downlink packet access (HSDPA) release 7, two data streams may simultaneously be transmitted to one user equipment (UE) using the same channelization codes. However, in poor channel conditions, transmitting one stream will provide higher throughput than transmitting two streams. Therefore, the standard includes a mechanism called stream switching, so that the network may revert to transmitting only one stream to a MIMO capable UE.

This stream switching operates on a per transmission time interval (TTI) basis. For each TTI, a radio base station (such as node B) decides if a single-stream or dual-stream transmission is to be used. To assist the node B, the UE reports its preferred choice of single-stream or dual-stream transmission. If the UE prefers single-stream transmission, one channel quality indicator (CQI) value is sent and if the UE prefers dual-stream transmission, two CQI values are sent to the node B.

Fundamentally, single-stream provides higher throughput than dual-stream when:
The channel quality is (qualities are) bad;
The difference between the two channel qualities is large;
The available transmit power is low.

As an example of a stream-switching algorithm, we may consider water-filling. In general, water-filling is the optimal way to distribute transmit power over n parallel channels, and it states the exact conditions when no power should be transmitted over any of the n channels, i.e., when that channel should be switched off. In the two channel case, this states that no transmission should take place over the channel with the worst quality whenever

$$\vert \frac{1}{{γ}_{1}} - \frac{1}{{γ}_{2}} \vert \geq P \qquad ( 2 )$$

where γᵢ is the normalized signal to interferens-plus-noise ratio (SINR) for channel i, and P is the available transmit power. For any values of γ₁,γ₂ and P, equation (2) may be used to determine if single-stream or dual-stream is preferred. In fact, for any value of P, equation (1) may be used to determine the set of γ₁,γ₂ where single-stream is preferred. This set is depicted in FIG. 2. In the regions to the upper left and lower right of each line, single-stream transmission is better than dual-stream transmission. For instance, for (γ₁,γ₂)=(15 dB,5 dB), dual-stream transmission is preferred for all the investigated powers, but for (γ₁,γ₂)=(−5 dB,5 dB), dual-stream is preferred if the available transmit power is 5 W or 10 W, whereas single-stream is better when the available transmit power is 1 W or 0.5 W. It is clear that the available power affects the stream selection. The comparison is somewhat simplified, since interference between the streams is ignored, leading to a too large preference for dual-stream transmission.

When considering HSDPA in particular, the number of available high speed physical downlink shared channel (HS-PDSCH) codes will also affect the choice: when few codes are available, dual-stream transmission becomes more advantageous.

Summing up, to make an optimum choice of single- or dual-stream transmission, quantities that are only accurately known at the receiver (channel qualities) and at the transmitter (available resources) are required.

In the straightforward solution, the UE selection of the number of streams will be based on a nominal allocation of power and codes. When the nominal resource allocation differs from the actual allocation, the choice may be incorrect. It is also not reasonable to update the nominal allocation very frequently using current signalling mechanisms, since this requires higher layer signalling, if at all possible. Although the node B can override the UE recommendation, the UE will provide the node B with all the relevant information for making an accurate transport format selection only for its preferred choice of number of streams.

### SUMMARY OF THE INVENTION

Accordingly, one objective with the present invention is to provide an improved method in a user equipment of facilitating the allocation of radio resources in a communication network, comprising a communication network node communicating with said user equipment by means of data stream transmissions over a radio interface on radio channels.

According to a first aspect of the present invention this objective is achieved through a method as defined in the characterising portion of claim 1, which specifies that the allocation of radio resources is facilitated by a method which performs the steps of predicting what power allocation said communication network node will use for next to said user equipment incoming data transmission, transmitting a channel quality message comprising information on if a single data stream transmission or if a multi data stream transmission is selected for said communication based on said power allocation prediction, whereby said communication network node is arranged to allocate available radio resources based on said channel quality message.

A further objective of the present invention is to provide an improved method in a communication network node of facilitating the allocation of radio resources in a communication network, comprising the communication network node communicating with a plurality of user equipments by means of data stream transmissions over a radio interface on radio channels.

According to a second aspect of the present invention this further objective is achieved through a method as defined in the characterising portion of claim 10, which specifies that the allocation of radio resources is facilitated by a method which performs the steps of receiving a channel quality message comprising information on if a single data stream transmission or if a multi data stream transmission is selected by said user equipment for said communication based on a power allocation prediction estimated by said user equipment, allocating available radio resources based on said received channel quality message.

A still further objective of the present invention is to provide an improved arrangement in a user equipment of facilitating the allocation of radio resources in a communication network, comprising a communication network node communicating with said user equipment by means of data stream transmissions over a radio interface on radio channels.

According to a third aspect of the present invention this further objective is achieved through an arrangement as defined in the characterising portion of claim 11, which specifies that the allocation of radio resources is facilitated by an arrangement which comprises means for predicting what power allocation said communication network node (15) will use for next to said user equipment incoming data transmission, and means for transmitting a channel quality message comprising information on if a single data stream transmission or if a multi data stream transmission is selected for said communication based on said power allocation prediction, whereby said communication network node is arranged to allocate available radio resources based on said channel quality message.

A yet further objective of the present invention is to provide an improved arrangement in a communication network node of facilitating the allocation of radio resources in a communication network, comprising said communication network node communicating with a plurality of user equipments by means of data stream transmissions over a radio interface on radio channels.

According to a fourth aspect of the present invention this further objective is achieved through an arrangement as defined in the characterising portion of claim 20, which specifies that the allocation of radio resources is facilitated by an arrangement which comprises means for receiving a channel quality message comprising information on if a single data stream transmission or if a multi data stream transmission is selected by said user equipment for said communication based on a power allocation prediction estimated by said user equipment, and means for allocating available radio resources based on said received channel quality message.

Further embodiments are listed in the dependent claims.

Thanks to the provision of a method and an arrangement in which HS-PDSCH power and code allocation is predicted by using information readily available at the UE, the stream-switching procedure in HSDPA MIMO systems is improved. Further, the availability of the correct CQI values at the node B is improved.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 shows a communication network architecture according to the present invention;

FIG. 2 is a diagram showing decision regions with water filling.

FIG. 3 is a flowchart illustrating the inventive method in a user equipment;

FIG. 4 is a flowchart illustrating the inventive method in a radio base station;

FIG. 5 is a simplified block diagram of an inventive user equipment and radio base station.

### DETAILED DESCRIPTION OF PREFERRED EMBODIMENTS

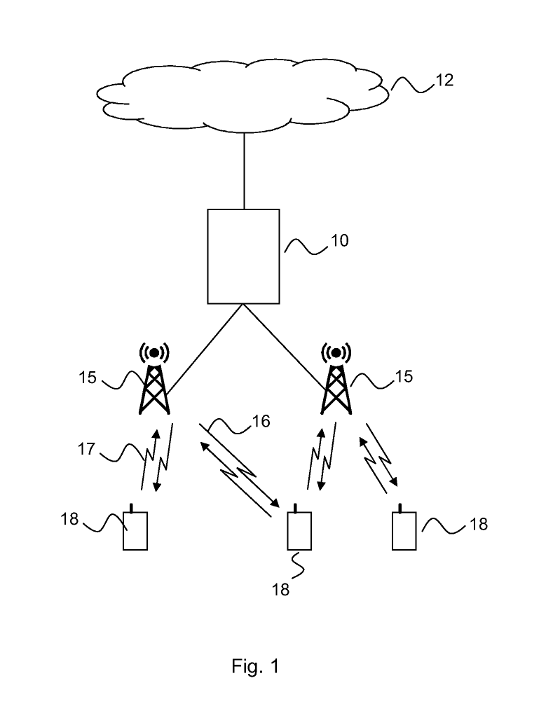

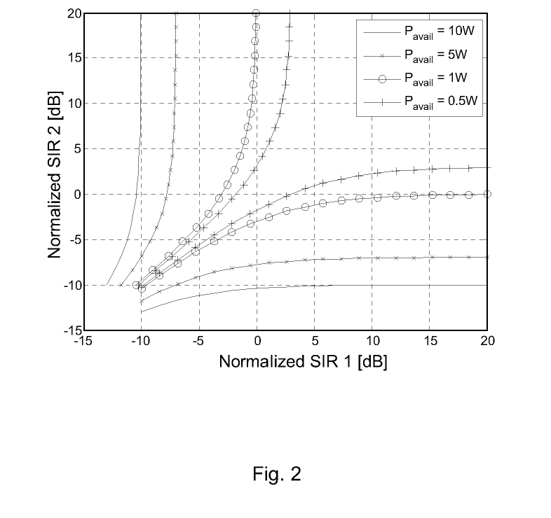

FIG. 1 depicts a communication system including a Radio Access Network (RAN), such as the UMTS Terrestrial Radio Access Network (UTRAN) architecture, comprising at least one Radio Base Station (RBS) (eNode B or Node B) 15 (two are shown in FIG. 1) connected to one or more Radio Network Controllers (RNCs) 10. The RAN is connected to a Core network (CN) 12. The RAN and the CN 12 provide communication and control for a plurality of user equipments (UE) 18 that each uses downlink (DL) channels 16 and uplink (UL) channels 17. For the reason of clarity, only one uplink channel is denoted 17 and one downlink channel denoted 16. On the downlink channel 16, the RBS 15 transmits to each user equipment 18 at respective power level. On the uplink channel 17, the user equipments 18 transmit data to the RBS 15 at respective power level.

According to a preferred embodiment of the present invention, the communication system is herein described as a HSDPA communication system. The skilled person, however, realizes that the inventive method and arrangement works very well on other packet based communications systems as well, such as a Long Term Evolution (LTE) system. The user equipments 18 may be mobile stations such as mobile telephones (“cellular” telephones) and laptops with mobile termination and thus can be, for example, portable, pocket, hand-held, computer-included or car-mounted mobile devices which communicate voice and/or data with the RAN.

As described above, the selection of the number of streams that maximizes the user throughput may be inaccurate since the actual resource allocation may differ from the nominal allocation.

One way of minimizing this error is to let the node B signal to the UE what allocation it would use for the next transmission. However, this would then require that this information be signalled to the UE using a fast downlink signalling channel.

Instead, we propose that the UE predicts what power and code allocation the node B will use for its subsequent data transmission on the HS-PDSCH. The UE would do this using only information that is anyway readily available. These predictions would then be used to select the number of streams, which then determines what type of CQI report is transmitted to the node B. Assuming that the prediction error is smaller than the error between nominal and actual allocation, the probability that the node B will have to override the UE preference is smaller.

The power and code allocations may be predicted in several ways, and some examples will be given later in this section.

Future allocations depend on the traffic situation and the operation of the node B scheduler. Providing an algorithm that is really capable to predict the future allocation is very difficult. The “predictors” discussed in the subsequent text simply assume that the next allocation will be the same as the current. More formally, they are actually estimators in the sense that the current state estimated based on current and past data. (In contrast a predictor estimates the future state using current and past data.)

In general, both power and code allocations are independent from TTI to TTI, but in many cases, the traffic situation is such that large and drastic changes in the allocations are uncommon. Of course, when a high-priority user is admitted, the power and code allocation change drastically. However, this situation should be relatively uncommon on the time scale of the stream-switching (TTI level). In contrast, new user admissions are much rarer (not more frequent than once every ten seconds).

### Predicting HS-PDSCH Code Allocations

The HS-PDSCH codes allocated for transmission on HS-PDSCH is signalled to the UE on the HS-SCCH to facilitate actual decoding of the data. Thus, the current code allocation is readily available without error. It is also reasonable to assume that the code allocation does not change rapidly and frequently: the code allocation may change if:
New sessions are admitted
In some cases, due to code multiplexing

Of course, the UE will have to select the number of streams before any transmission has been received on the HS-PDSCH. In this case, the UE can resort to a nominal code allocation, i.e., to the straightforward solution described above. Then the initial selection of the number of streams will be based on a code allocation that may be different from the one subsequently used. Since this procedure is only used in a transient state, the problem is small.

There may also be (rare) cases where a UE hasn't received any data on the HS-PDSCH for a long time. The latest code allocation may then be outdated. In such a case, the UE may also resort to a nominal allocation. Again, the discrepancy between nominal and actual will only remain for a short period of time.

### Predicting HS-PDSCH Power Allocation

Unlike the code allocation, the HS-PDSCH power allocation is not signalled to the UE. Thus, the UE has to estimate the current power allocation from the measured received signal. The usefulness of this method then depends on the accuracy of this estimation.

If the accuracy of an estimation using only the very latest measurement of the received HS-PDSCH power is deemed insufficient, some filtering or averaging can be applied in the UE. It is also possible to let a nominal power affect the estimation to improve the accuracy in situations where reliable measurement data is unavailable. In particular, accuracy may be insufficient during the initial transmission, or after long gaps in the scheduling.

One particularly attractive tool for performing this filtering is a Kalman filter. In this context, the Kalman estimator of the current HS-PDSCH power would be of the form:

$$\hat{p} ( t + 1 ) = a \hat{p} ( t ) + ( 1 - a ) * {p}_{nom} + K ( t ) ( {p}_{meas} ( t ) - \hat{p} ( t ) ) \\ K ( t ) = \frac{aP ( t )}{P ( t ) + {r}_{2}} \\ P ( t + 1 ) = {a}^{2} P ( t ) + {r}_{1} - \frac{{a}^{2} {P}^{2} ( t )}{P ( t ) + {r}_{2}} \qquad ( 3 )$$

Above, K(t) is called the Kalman gain, and states how much significance should be put on the measurement Vₘₑₐₛ(t): a high value of K(t) means “trust this measurement”, and a small value of K(t) means “don't trust this measurement”. The magnitude of K(t) is in turned controlled by the variables r₁ and r₂, or more specifically, by the fraction r₁/r₂: the larger r₁/r₂ the more confidence is put on the measurement. We also see that if K(t) is zero for some period of time, \hat{p}(t) will tend to pₙₒₘ. The constant a will determine the rate with which the Kalman estimate will tend to the nominal power: when a is close to zero, the convergence will be slow, and if it is close to one, the convergence will be fast. For an actual estimator, the parameters r₁, r₂ and a can be tuned to achieve optimum performance.

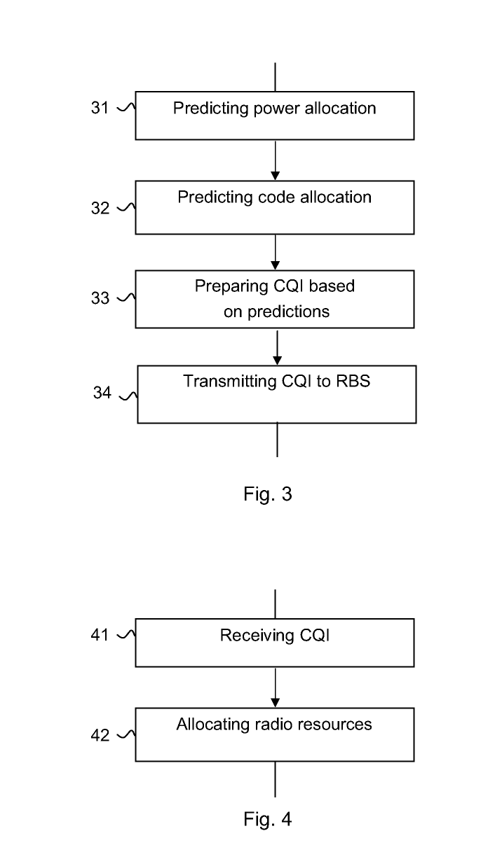

The procedure in a user equipment of facilitating the allocation of radio resources in a communication network, comprising a communication network node (such as node B) communicating with said user equipment by means of data stream transmissions over a radio interface on radio channels, shown in FIG. 3 is as follows:
Predicting what power allocation said communication network node will use for next to said user equipment incoming data transmission (step 31). The prediction is described in more detail above;
Predicting what code allocation said communication network node 15 will use for next to said user equipment incoming data transmission (step 32). The prediction is described in more detail above;
Preparing a channel quality message (step 33) comprising information, based on said power and code allocation prediction, if a single data stream transmission or if a multi data stream transmission is selected for said communication;
Transmitting said channel quality message to said communication network node (step 34), whereby said communication network node is arranged to allocate available radio resources based on said channel quality message.

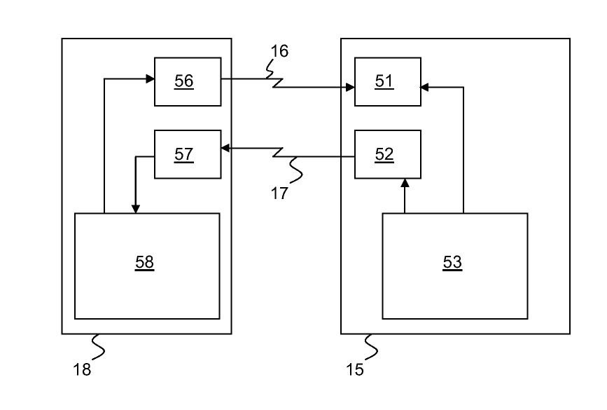

The procedure in a communication network node, such as node B, of facilitating the allocation of radio resources in a communication network, comprising the communication network node communicating with a user equipment by means of data stream transmissions over a radio interface on radio channels, shown in FIG. 4 is as follows:
Receiving a channel quality message (step 41) comprising information on if a single data stream transmission or if a multi data stream transmission is selected by said user equipment for said communication based on a power allocation prediction estimated by said user equipment;
Allocating available radio resources based on said received channel quality message (step 42).

FIG. 5 is a block diagram showing a user equipment 18 and a radio base station (RBS) 15, such as Node B, for facilitating the allocation of radio resources in a communication network, comprising the RBS 15 communicating with a user equipment 18 by means of data stream transmissions over a radio interface on radio channels. The RBS 15 comprises a radio transmitter 52 and a receiver 51. The transmitter 52 is transmitting data to a receiver 57 of the user equipment 18 over the radio interface on the downlink channel 17. The receiver 51 is receiving data from the user equipment 18 on the uplink channel 16. According to a preferred embodiment of the present invention, the receiver 51 of the RBS 15 is arranged to receive a channel quality message (CQI) comprising information on if a single data stream transmission or if a multi data stream transmission is selected by said user equipment for said communication based on a power allocation prediction estimated by said user equipment. The RBS 15 further comprises means 53 for allocating available radio resources based on said received channel quality message.

The user equipment 18 comprises a radio transmitter 56 arranged to transmit data packets to the receiver 51 of the RBS 15 over the radio interface on the uplink channel 16 and a receiver 57 arranged to receive data packets transmitted from the transmitter 52 of the RBS 15 on the downlink channel 17. The user equipment 18 further comprises means 58 for predicting what power and code allocation the RBS 15 will use for next to said user equipment incoming data transmission. The transmitter 56 of the user equipment 18 is further arranged to transmit to the RBS 15 a channel quality message comprising information, based on said power and code allocation prediction, if a single data stream transmission or if a multi data stream transmission is selected for said communication, whereby the RBS 15 is arranged to allocate available radio resources based on said channel quality message.

Further, the HS-DSCH power and code allocations may be used to estimate the CQI, which is then reported to node B in order to improve the accuracy of the CQI reports. Node B makes the same prediction as the UE to know what code and/or power allocations the UE has based its CQI estimation on. If the actual and predicted allocations differ, the node B scales the reported CQIs to compensate for this difference. As previously described, this scaling is not exact; however the smaller the difference between predicted and actual allocations, the smaller the scaling error.

Thus, the procedure in a user equipment for improving the accuracy of the CQI reports may comprise the steps of:
predicting at least one resource allocation that affects the CQI by using information that is already available in the receiving unit due to previous transmissions from the transmitting unit;
utilizing said at least one prediction of resource allocation for estimating a CQI;
reporting said estimated CQI to the transmitting unit.

Hereby, the invention improves accuracy of the CQI reports in MIMO systems by predicting resource allocations to be used for estimating CQI by using information readily available at the UE to estimate the CQI. It is reasonable to assume that such dynamic prediction will be more accurate than any nominal fixed selection so that the need for adjustment of the CQI in the unit that receives the reports is reduced or eliminated. Furthermore, since said prediction is based upon information that is already available in the receiving unit, there is no need for extra signaling.

The procedure in a communication network node for improving the accuracy of the CQI reports may comprise the steps of:
receiving from the receiving unit an estimated CQI report, at least partly based upon a predicted resource allocation, said prediction being made by the receiving unit based on information that is available in the receiving unit due to previous transmissions from the transmitting unit;
comparing the predicted resource allocations used in estimating the CQI with the actual allocations; and
if the predicted and actual allocation differ, scaling the reported CQI to compensate for the difference.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural and vice versa.

Numerals included within parentheses in the accompanying claims are intended to assist understanding of the claims and should not be construed in any way to limit subject matter claimed by these claims.

1. A method in a user equipment of facilitating the allocation of radio resources in a communication network, comprising a communication network node communicating with said user equipment by means of data stream transmissions over a radio interface on radio channels, the method comprising:
predicting what power allocation said communication network node will use for next to said user equipment incoming data transmission;
transmitting a channel quality message comprising information on if a single data stream transmission or if a multi data stream transmission is selected for said communication based on said power allocation prediction, wherein said communication network node is arranged to allocate available radio resources based on said channel quality message.

2. The method according to claim 1, wherein said power allocation is predicted by estimating a current power allocation.

3. The method according to claim 2, wherein said power allocation is estimated by measuring a received signal.

4. The method according to claim 2, wherein said power allocation is estimated using a filter.

5. The method according to claim 4, wherein said filter is a Kalman filter.

6. The method according to claim 2, wherein said power allocation is estimated by using a nominal power value.

7. The method according to claim 1, the method further comprising the steps of:
predicting what code allocation said communication network node will use for next to said user equipment incoming data transmission;
further basing said information in said channel quality message on said code allocation prediction.

8. The method according to claim 7, wherein said code allocation is predicted by estimating a current code allocation.

9. The method according to claim 7, wherein said code allocation is predicted by using a nominal code allocation value.

10. A method in a communication network node of facilitating the allocation of radio resources in a communication network, comprising said communication network node communicating with a plurality of user equipments by means of data stream transmissions over a radio interface on radio channels, the method comprising:
receiving a channel quality message comprising information on if a single data stream transmission or if a multi data stream transmission is selected by said user equipment for said communication based on a power allocation prediction estimated by said user equipment;
allocating available radio resources based on said received channel quality message.

11. An arrangement in a user equipment for facilitating the allocation of radio resources in a communication network, comprising a communication network node communicating with said user equipment by means of data stream transmissions over a radio interface on radio channels, the arrangement comprising:
means for predicting what power allocation said communication network node will use for next to said user equipment incoming data transmission;
means for transmitting a channel quality message comprising information on if a single data stream transmission or if a multi data stream transmission is selected for said communication based on said power allocation prediction, wherein said communication network node is arranged to allocate available radio resources based on said channel quality message.

12. The arrangement according to claim 11, wherein said means for predicting power allocation is arranged to estimate a current power allocation.

13. The arrangement according to claim 12, wherein said means for predicting power allocation is arranged to measure a received signal in order to estimate said current power allocation.

14. The arrangement according to claim 12, wherein said means for predicting power allocation is arranged to use a filter in order to estimate said current power allocation.

15. The arrangement according to claim 14, wherein said filter is a Kalman filter.

16. The arrangement according to claim 12, wherein said means for predicting power allocation is arranged to use a nominal power value in order to estimate said current power allocation.

17. The arrangement according to claim 11, the arrangement further comprising:
means for predicting what code allocation said communication network node will use for next to said user equipment incoming data transmission;
means for further basing said information in said channel quality message on said code allocation prediction.

18. The arrangement according to claim 17, wherein said means for predicting code allocation is arranged to estimate a current code allocation.

19. The arrangement according to claim 17, wherein said means for predicting code allocation is arranged to use a nominal code allocation value.

20. An arrangement in a communication network node for facilitating the allocation of radio resources in a communication network, comprising a communication network node communicating with said user equipment by means of data stream transmissions over a radio interface on radio channels, the arrangement comprising:
means for receiving a channel quality message comprising information on if a single data stream transmission or if a multi data stream transmission is selected by said user equipment for said communication based on a power allocation prediction estimated by said user equipment;
means for allocating available radio resources based on said received channel quality message.
